(19) United States
(12) Patent Application Publication
(10) Pub. No.: US 2016/0192225 A1
(43) Pub. Date: Jun. 30, 2016

(54) METHOD AND APPARATUS FOR TRANSMITTING CHANNEL INFORMATION REPORT MESSAGE IN CLOUD RADIO ACCESS NETWORK (C-RAN) ENVIRONMENT

(71) Applicant: LG Electronics Inc., Seoul (KR)

(72) Inventors: Hyunsoo KO, Seoul (KR); Kungmin PARK, Seoul (KR); Ilmu BYUN, Seoul (KR); Heejeong CHO, Seoul (KR); Hyeyoung CHOI, Seoul (KR)

(21) Appl. No.: 14/586,100

(22) Filed: Dec. 30, 2014

(51) Int. Cl. H04W 24/10; H04W 72/08; H04L 5/00

(52) U.S. Cl. CPC H04W 24/10; H04L 5/0057; H04W 72/085; H04W 88/08

(57) ABSTRACT

A method and apparatus for transmitting a channel information report message in a cloud radio access network (C-RAN) environment are disclosed. A method for transmitting a channel information report message by a user equipment (UE) under a cloud radio access network (C-RAN) environment includes: receiving a reference signal (RS) including a reference signal (RS) configuration indicator from a specific base station (BS) contained in a UE-oriented virtual cell formed by the UE; measuring channel information regarding each of one or more base stations (BSs) contained in the UE-oriented virtual cell on the basis of the RS configuration indicator; and transmitting a channel information report message including the measured channel information to the specific base station (BS), wherein the RS configuration indicator includes one or more RS resources used for channel information measurement, and the one or more RS resources are allocated to one or more base stations (BSs) contained in the UE-oriented virtual cell.

### BACKGROUND OF THE INVENTION

1. Field of the Invention

The present invention relates to a radio access network (RAN) system, and more particularly to a method and apparatus for generating a channel information report message in a cloud radio access network (C-RAN) environment.

2. Discussion of the Related Art

Generally, a radio access network (RAN) comprised of a base station (BS) and a user equipment (UE) provides various kinds of communication services including voice or data to the UE on the basis of one or more BSs. One BS may include one or more cells.

Recently, with the increasing development of wireless communication technologies, the number of communication service users is rapidly increasing, and many communication companies have made efforts to install additional BSs so as to meet the amount of traffic increasing in proportion to the increasing number of service users. A

Therefore, the RAN structure has been changed from a centralized BS format based on a macro cell to the distributed BS format in which various types of small cells such as a pico cell, a femto cell, etc, interact with the macro cell.

However, such installation of additional BSs needed for accommodating the rapidly increasing traffic unavoidably encounters new limitation in terms of costs and frequency resources.

Therefore, many developers and companies are making efforts to introduce a UE-oriented logical cell based service provision unit distinguished from a conventional BS-oriented physical cell based service provision unit into the above-mentioned RAN.

If the UE-oriented logical cell based service provision unit is introduced into the RAN, various attempts having been provided for interference cancellation in the conventional BS-oriented physical cell based service provision unit are also required for the UE-oriented logical cell based service provision unit.

Therefore, in order to attempt to perform interference cancellation in the logical cell based service provision unit, the UE has to measure and report a channel of the logical cell based service provision unit. In this case, the number of channels to be measured by the UE increases, the number of reference signals (RSs) to be sent to the UE for the above channel measurement is also increased, so that a method for effectively reducing the above-mentioned load needs to be developed and proposed.

### SUMMARY OF THE INVENTION

Accordingly, the present invention is directed to a method and apparatus for transmitting a channel information report message in a cloud radio access network (C-RAN) environment that substantially obviate one or more problems due to limitations and disadvantages of the related art.

An object of the present invention is to provide a method for transmitting a channel information report message in a cloud radio access network (C-RAN) environment.

Another object of the present invention is to provide a method for transmitting reference signals (RSs) to reduce the number of RSs used for channel measurement in a cloud radio access network (C-RAN) environment.

Another object of the present invention is to provide a method for transmitting a channel information report message to reduce complexity of UE channel estimation in a C-RAN environment.

Another object of the present invention is to provide an apparatus for supporting the above-mentioned methods.

It is to be understood that technical objects to be achieved by the present invention are not limited to the aforementioned technical objects and other technical objects which are not mentioned herein will be apparent from the following description to one of ordinary skill in the art to which the present invention pertains.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method for transmitting a channel information report message by a user equipment (UE) under a cloud radio access network (C-RAN) environment includes: receiving a reference signal (RS) including a reference signal (RS) configuration indicator from a specific base station (BS) contained in a UE-oriented virtual cell formed by the UE; measuring channel information regarding each of one or more base stations (BSs) contained in the UE-oriented virtual cell on the basis of the RS configuration indicator; and transmitting a channel information report message including the measured channel information to the specific base station (BS), wherein the RS configuration indicator includes one or more RS resources used for channel information measurement, and the one or more RS resources are allocated to one or more base stations (BSs) contained in the UE-oriented virtual cell.

The UE-oriented virtual cell may be formed by the user equipment (UE) on the basis of not only a network state of the C-RAN, but also intensity and load information of the reference signal (RS) received from each BS contained in the C-RAN environment.

The measured channel information may include spatial channel information and channel quality information, wherein the spatial channel information is used to decide a transmission (Tx) precoder and a transmission (Tx) rank of signals needed for reducing interference generated from the specific base station (BS), and the channel quality information is used to decide not only a transmit (Tx) resources of the signals needed for the interference reduction but also a modulation rate.

The transmitting the channel information report message may include: separating the spatial channel information and the channel quality information from each other, and transmitting the separated spatial channel information and the channel information.

The reference signal (RS) configuration indicator may further include: a reference signal (RS) resource allocated to each base station (BS) contained in other UE-oriented virtual cell neighboring with the UE-oriented virtual cell.

The measuring the channel information may include: measuring channel information of each BS contained in the UE-oriented virtual cell and channel information of each BS contained in the other UE-oriented virtual cell, on the basis of the reference signal configuration indicator further including a reference signal (RS) resource allocated to each BS contained in the other UE-oriented virtual cell.

At least one overlap base station (BS) simultaneously contained in the UE-oriented virtual cell and other UE-oriented virtual cell neighboring with the UE-oriented virtual cell may be present. Among channel information measured on the basis of the RS configuration indicator received from the specific BS contained in the UE-oriented virtual cell, channel information of the overlap BS may be determined to be channel information regarding the overlap BS contained in the other UE-oriented virtual cell.

The RS configuration indicator may further include information regarding the number of transmission (Tx) layers.

In accordance with another aspect of the present invention, an apparatus for transmitting a channel information report message in a cloud radio access network (C-RAN) environment includes: a radio frequency (RF) unit configured to include a transmitter and a receiver; and a processor connected to the transmitter and the receiver to support communication of the apparatus, wherein the processor receives a reference signal (RS) including a reference signal (RS) configuration indicator from a specific base station (BS) contained in a UE-oriented virtual cell formed by a user equipment (UE), measures channel information regarding each of one or more base stations (BSs) contained in the UE-oriented virtual cell on the basis of the RS configuration indicator, and transmits a channel information report message including the measured channel information to the specific base station (BS), wherein the RS configuration indicator includes one or more RS resources used for channel information measurement, and the one or more RS resources are allocated to one or more base stations (BSs) contained in the UE-oriented virtual cell.

The processor may form the UE-oriented virtual cell on the basis of not only a network state of the C-RAN, but also intensity and load information of the reference signal (RS) received from each BS contained in the C-RAN environment.

The measured channel information may include spatial channel information and channel quality information. The spatial channel information may be used to decide a transmission (Tx) precoder and a transmission (Tx) rank of signals needed for reducing interference generated from the specific base station (BS), and the channel quality information may be used to decide not only a transmit (Tx) resources of the signals needed for the interference reduction but also a modulation rate.

The processor may separate the spatial channel information and the channel quality information from each other, and transmit the separated spatial channel information and the channel information.

The reference signal (RS) configuration indicator may further include: a reference signal (RS) resource allocated to each base station (BS) contained in other UE-oriented virtual cell neighboring with the UE-oriented virtual cell.

The processor may measure channel information of each BS contained in the UE-oriented virtual cell and channel information of each BS contained in the other UE-oriented virtual cell, on the basis of the reference signal configuration indicator further including a reference signal (RS) resource allocated to each BS contained in the other UE-oriented virtual cell.

At least one overlap base station (BS) simultaneously contained in the UE-oriented virtual cell and other UE-oriented virtual cell neighboring with the UE-oriented virtual cell may be present. The processor may determine channel information of the overlap BS from among channel information measured on the basis of the RS configuration indicator received from the specific BS contained in the UE-oriented virtual cell, to be channel information regarding the overlap BS contained in the other UE-oriented virtual cell.

The RS configuration indicator may further include information regarding the number of transmission (Tx) layers.

In accordance with another aspect of the present invention, a method for receiving a channel information report message by a base station (BS) contained in a UE-oriented virtual cell formed by a user equipment (UE) under a cloud radio access network (C-RAN) environment includes: transmitting a reference signal (RS) including a reference signal (RS) configuration indicator to the UE; and receiving a channel information report message including channel information of each of one or more base stations (BSs) contained in the UE-oriented virtual cell measured on the basis of the RS configuration indicator from the UE, wherein the RS configuration indicator includes one or more RS resources used for channel information measurement, and the one or more RS resources are allocated to one or more base stations (BSs) contained in the UE-oriented virtual cell.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention, illustrate embodiments of the invention and together with the description serve to explain the principle of the invention.

FIG. 1 is a conceptual diagram illustrating a base station (BS) and user equipments (UEs) for use in a general radio access network (RAN) system.

FIG. 2 is a conceptual diagram illustrating a cloud radio access network (C-RAN) according to the embodiment.

FIGS. 3(a) and 3(b) are conceptual diagrams illustrating a UE-oriented virtual cell according to the embodiment.

FIGS. 4(a) and 4(b) are exemplary graphs illustrating the result of comparison between performances depending on the size and scheme of the UE-oriented virtual cell.

FIG. 5 is a graph illustrating the result of performance comparison between various methods for forming the UE-oriented virtual cell according to the embodiment

FIG. 6 illustrating the relationship between one or more UE-oriented virtual cells in the C-RAN environment according to the embodiment.

FIG. 7 is a flowchart illustrating a method for transmitting a channel information report message in a C-RAN environment according to the embodiment.

FIG. 8 is a block diagram illustrating an apparatus for transmitting a channel information report message in the C-RAN environment according to the embodiment.

### DESCRIPTION OF SPECIFIC EMBODIMENTS

Reference will now be made in detail to the preferred embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the present invention.

The following detailed description includes specific details in order to provide a thorough understanding of the present invention. However, it will be apparent to those skilled in the art that the present invention may be practiced without such specific details. For example, the following description will be given centering upon a radio access network (RAN) serving as a cloud radio access network (C-RAN), but the present invention is not limited thereto and the following embodiments can also be applicable to other radio access network (RANs) including 3GPP LTE, LTE-A, WIMAX or WiFi systems.

In some cases, in order to prevent ambiguity of the concepts of the present invention, conventional devices or apparatuses well known to those skilled in the art will be omitted and be denoted in the form of a block diagram on the basis of important functions of the present invention. Wherever possible, the same reference numbers will be used throughout the drawings to refer to the same or like parts.

In the whole part of the specification of the present invention, if it is assumed that a certain part includes a certain component, the term ‘comprising or including’ means that a corresponding component may further include other components unless a specific meaning opposed to the corresponding component is written.

In addition, another term ‘ . . . part’, “ . . . unit’, ‘module’ or the like means a unit for processing at least one function or operation, and this unit may be implemented by hardware, software, or a combination thereof. As used in the specification and appended claims, the terms “a”, “an”, “one”, “the” and other similar terms include both singular and plural forms, unless context clearly dictates otherwise.

It should be noted that specific terms disclosed in the present invention are proposed for convenience of description and better understanding of the present invention, and the use of these specific terms may be changed to other formats within the technical scope or spirit of the present invention. Unless otherwise defined, all terms used herein, including technical or scientific terms, have the same meanings as understood by those skilled in the art. Terms defined in a generally used dictionary may be analyzed to have the same meaning as the context of the relevant art and may not be analyzed to have ideal meaning or excessively formal meaning unless clearly defined in the present application.

In description of the present invention, the terms “first” and “second” may be used to describe various components, but the components are not limited by the terms. The terms may be used to distinguish one component from another component. For example, a first component may be called a second component and a second component may be called a first component without departing from the scope of the present invention.

Reference will now be made in detail to the preferred embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the present invention.

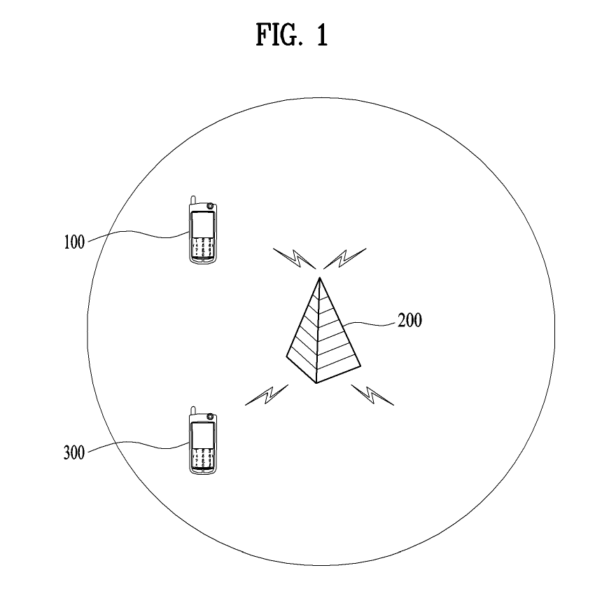

FIG. 1 is a conceptual diagram illustrating a base station (BS) and user equipments (UEs) for use in a general radio access network (RAN) system.

Referring to FIG. 1, the RAN system 100 includes user equipments (UEs) 100 and 300 and a base station (BS) 200. Although the RAN system of FIG. 1 includes only one BS for convenience of description and better understanding of the present invention, it should be noted that one or more BSs and/or one or more UEs may also be contained in the RAN system

In the following description, assume that UE (100, 300) is a generic term for a mobile or fixed user-end device such as a terminal, a mobile station (MS), a mobile subscriber station (MSS), a subscriber station (SS), an advanced mobile station (AMS), a wireless terminal (WT), a Machine-Type-Communication (MTC) device, a Machine-to-machine (M2M) device, and a Device-to-Device (D2D) device.

In addition, the term “base station (BS)” is a terminal node of a network directly communicating with the UEs (100, 300), and may be replaced with a fixed station, a Node B, an eNode B (eNB), or the like.

Any one of all wireless communication devices based on either radio waves or infrared rays may be used as a communication unit between the BS 200 and the UEs (100, 300), and all kinds of wireless communication units to be developed in the future can be used as the communication unit.

Although transmit/receive (Tx/Rx) antennas of the BS 200 and the UEs (100, 300) are not shown in FIG. 1, the BS 200 and the UEs (100, 300) may include a plurality of Tx/Rx antennas. Therefore, the BS 200 and the UEs (100, 300) according to the embodiment may support Multiple Input Multiple Output (MIMO) systems, and may support Single User-MIMO (SU-MIMO) and Multi User-MIMO (MU-MIMO) schemes.

In addition, one or more BSs other than the BS 200 may also be contained in one UE-oriented virtual cell, so that it may also be possible to support the SU-MIMO and MU-MIMO schemes on the basis of the UE-oriented virtual cell.

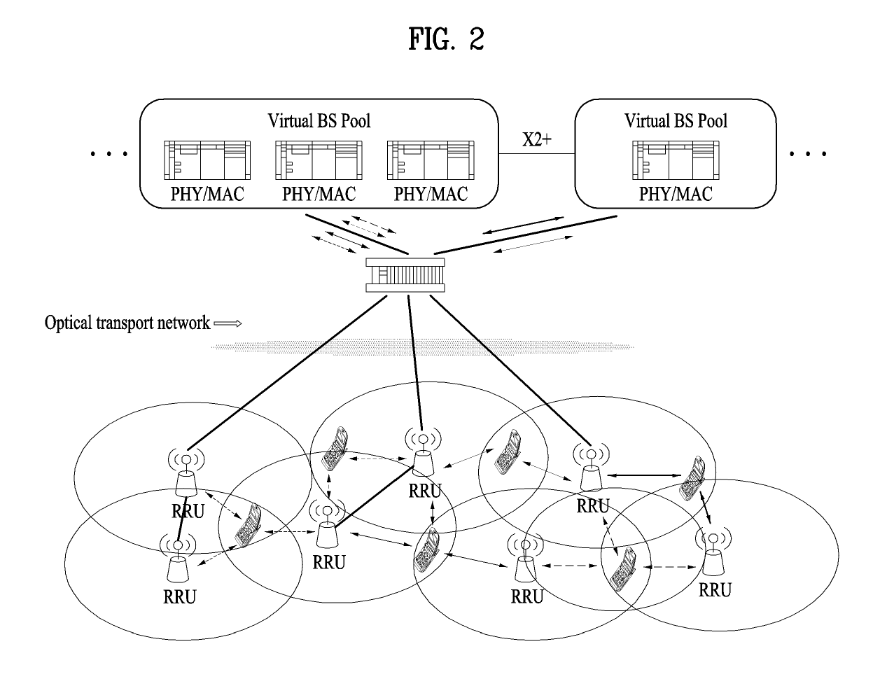

FIG. 2 is a conceptual diagram illustrating a cloud radio access network (C-RAN) according to the embodiment.

The C-RAN system can overcome economical limitation in terms of installation of additional BSs needed for meeting traffic requirements of the rapidly increasing users, and is proposed as the next-generation network to overcome the limitation in restricted frequency resources.

As described above, a typical management scheme of the radio access network (RAN) is a distributed system in which all BSs can process the user requirements using a maximum amount of resources allocated to each BS.

However, the C-RAN system is a centralized system in which BSs are interconnected through a backhaul so as to maximize efficiency of radio resources and include the cloud computing concept for central processing.

That is, the C-RAN may include a virtual cell or a virtual base station, an access control server for controlling the virtual cell or the virtual base station, and a core network cloud server (e.g., a resource management server, accounting/authentication server, etc.), and respective elements of the C-RAN may directly interact with elements of the core network (CN).

The C-RAN has the following implementation technologies. First, the C-RAN has a technology for implementing the real-time cloud computing server to implement the centralized processing. Second, the C-RAN has a technology for implementing a backhaul network capable of transmitting a variety of high-capacity information by connecting the BS to the cloud server. Third, the C-RAN has a technology for implementing the BS having a BS coordinated communication function, a low-power consumption function, and the like.

In case of using the C-RAN having the above-mentioned first to third characteristics, the centralized resource management can be achieved and all services can be processed at an upper end of the BS, so that the problem encountered by the increasing costs needed for installation of additional BSs can be solved and the inter-BS coordinated communication for cell performance improvement can be easily implemented.

Referring back to FIG. 2, the C-RAN includes a plurality of Radio Remote Units (RRUs) connected to a virtual BS pool through an optical transport network. In this case, the virtual BS may include a physical (PHY) layer and a MAC layer. The individual virtual BSs may be interconnected through an X2 interface, and one or more RRUs may be controlled through at least one virtual BS.

In addition, whereas the conventional art fixes a unique cell region for each RRU to each RRU, the embodiment can dynamically adjust the RRU cluster (BS cluster) in the C-RAN environment so that it forms a UE-oriented virtual cell. That is, the embodiment can construct the UE-oriented virtual cell instead of the legacy BS-oriented cell. A detailed description of the UE-oriented virtual cell will be given below.

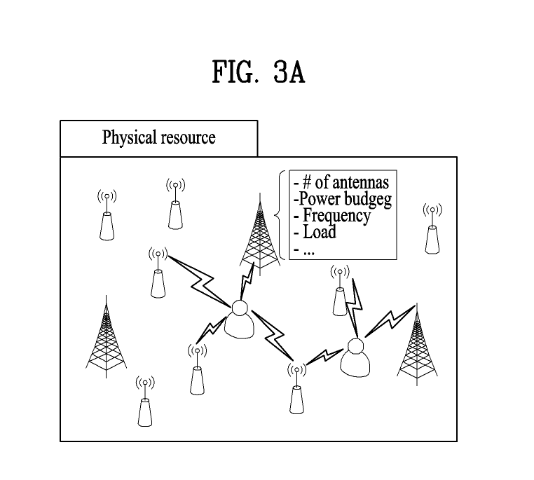

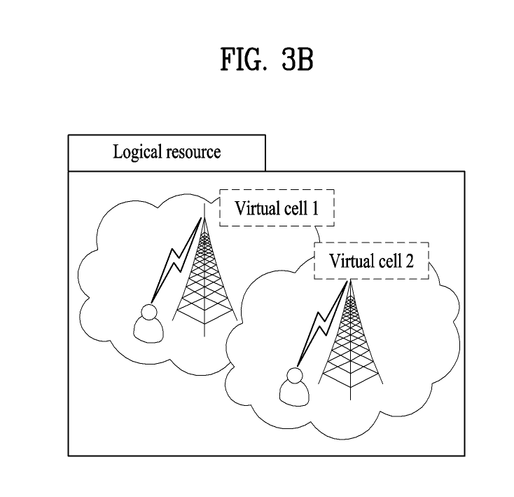

FIGS. 3(a) and 3(b) are conceptual diagrams illustrating a UE-oriented virtual cell according to the embodiment.

Referring to FIG. 3, FIG. 3(a) shows the BS-oriented cell and physical resource allocation, and FIG. 3(b) shows the UE-oriented virtual cell and logical resource allocation.

If the cell is formed on the basis of a BS and a communication service is provided to the UEs on the basis of the corresponding BS as shown in FIG. 3(a), performance of each BS may indicate a physical resource of the network. In this case, power budget, a frequency band, the number of antennas, and load of each BS may be specified as a physical resource of the corresponding cell.

However, assuming that the UE can receive the same QoS/QoE (Quality of Service/Quality of Experience) services with the same costs under the same condition, information as to whether the corresponding service is received from a macro cell, information as to whether the corresponding service is received from a femto cell or a pico cell, or information as to whether the corresponding service is simultaneously received from a plurality of cells is of little importance.

From the viewpoint of the UE, the most important thing is that physical BSs appropriate for the UE are collected so that a UE-oriented virtual cell is constructed as shown in FIG. 3(b).

Assuming that each UE has each UE-oriented virtual cell, this means that BS clusters overlap with each other on the basis of the UE. However, interference affecting each UE can be managed by coordination between the BSs, so that interference management can be more efficiently performed than the BS-oriented interference management.

That is, if each UE-oriented virtual cell for each UE is configured as shown in FIG. 3(b), although the BS being physically identical to the BS-oriented cell shown in FIG. 3(a) is used, the same problem as in the cell edge user having a relative penalty can be eliminated.

In more detail, assuming that each UE has each UE-oriented virtual cell as shown in FIG. 3(b), i.e., assuming that the BS clusters overlapping with each other form the UE-oriented virtual cell, the BSs contained in the virtual cell is connected through a backhaul, and the BSs can simultaneously transmit data to the above UE. In this case, the BS causing interference may be helpful for signal transmission, so that interference can be easily cancelled, resulting in implementation of a high data transfer rate.

In addition, according to the most ideal case, all BSs contained in the network fully cooperate with each other so that one huge virtual MIMO system can be implemented. In this case, all interference contained in the network can be fully cancelled.

However, in order to implement one virtual MIMO system through full cooperation of all BSs, it is necessary for each UE to have data to be transmitted to the UE. Assuming that the network is increased in size and the number of UEs increases, excessive or huge load may be applied to a backhaul link.

It is necessary to measure channel information among all UEs and all BSs, the measurement result should be fed back to the network, and this information should be shared by all BSs, so that overhead of the network is excessively increased.

In order to address the above-mentioned issue, only some BSs, instead of all BSs contained in the network, cooperate with each other to form the BS cluster.

If the UE-oriented virtual cell (BS cluster) is formed by cooperation of only some BSs, interference is controlled on the basis of a cluster through coordination of only some BSs contained in the same cluster so that the entire performance can be increased, instead of increasing performance by wholly controlling network interference. As a result, the above-mentioned problems can also be solved.

Therefore, the UE-oriented virtual cell may indicate one-UE-based virtual cell including only some BSs, information as to whether a method for forming the UE-oriented virtual cell (BS cluster) including some BSs is efficient in terms of costs and performance will hereinafter be described.

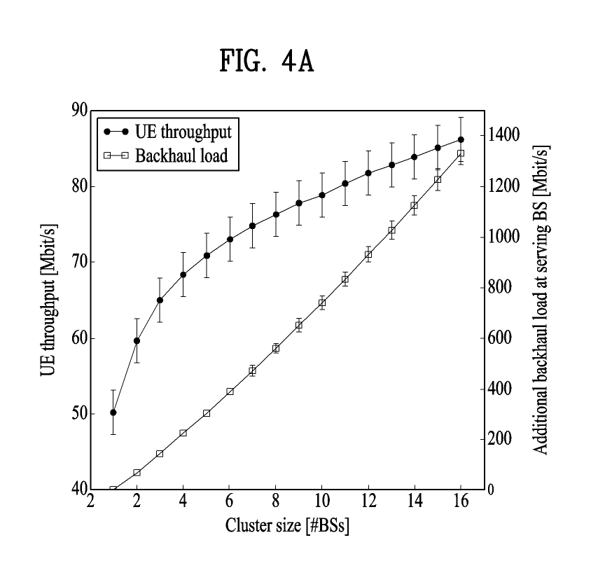

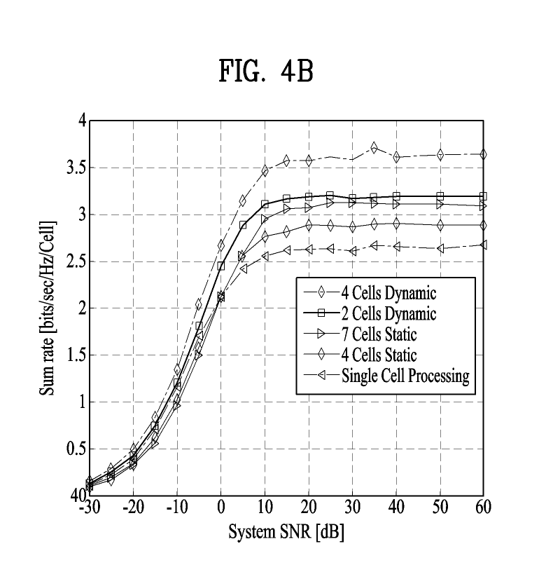

FIGS. 4(a) and 4(b) are exemplary graphs illustrating the result of comparison between performances depending on the size and scheme of the UE-oriented virtual cell.

FIG. 4(a) shows a difference in size of the BS cluster, i.e., a difference in performance and costs depending on the size variation of the UE-oriented virtual cell. FIG. 4(b) shows the result of performance comparison between a method for dynamically forming the BS cluster (i.e., UE-oriented virtual cell) and a method for statically forming the BS cluster (i.e., UE-oriented virtual cell).

Referring to FIG. 4(a), a horizontal axis may indicate a cluster size, a vertical axis may indicate a UE throughput, and a graph may indicate UE performance and costs in terms of a UE transfer rate and backhaul load.

As can be seen from FIG. 4(a), the cluster size and the performance and costs are in the relationship of a trade-off. That is, as the cluster size increases, the performance logarithmically increases. It can be recognized that the backhaul load linearly increases. If the cluster size increases by a predetermined size or higher, lost costs may be larger than performance gain capable of being obtained.

Therefore, it is necessary to establish the proper-sized cluster.

FIG. 4(b) shows the result of performance comparison indicating whether the BS cluster is statically or dynamically formed. This means whether the problem of the cluster edge can be addressed or not.

The above-mentioned cluster edge problem may indicate that performance of a UE located at a cluster edge is deteriorated due to the reason similar to performance deterioration of the cell-edge UEs in the legacy cellular network. In more detail, the transmission distance of a data signal is long and the transmission distance of the interference signal is short, so that the performance deterioration occurs.

Referring to FIG. 4(b), the case in which two cells (2 Cells) dynamically form the BS cluster has a higher performance than the other case in which 7 cells (7 Cells) statically forms the BS cluster.

In conclusion, in the case of statically forming the cluster, although many more BSs are used, the above-mentioned cluster edge problem may continuously occur. Assuming that the BS cluster is dynamically formed in response to the UE to be used for data transmission, the above-mentioned cluster edge effect can be relatively improved. As a result, it can be recognized that the BS cluster can be dynamically established.

A method for dynamically forming the proper-sized BS cluster (i.e., the proper-sized UE-oriented virtual cell) according to respective conclusions of FIGS. 4(a) and 4(b) will hereinafter be described in detail.

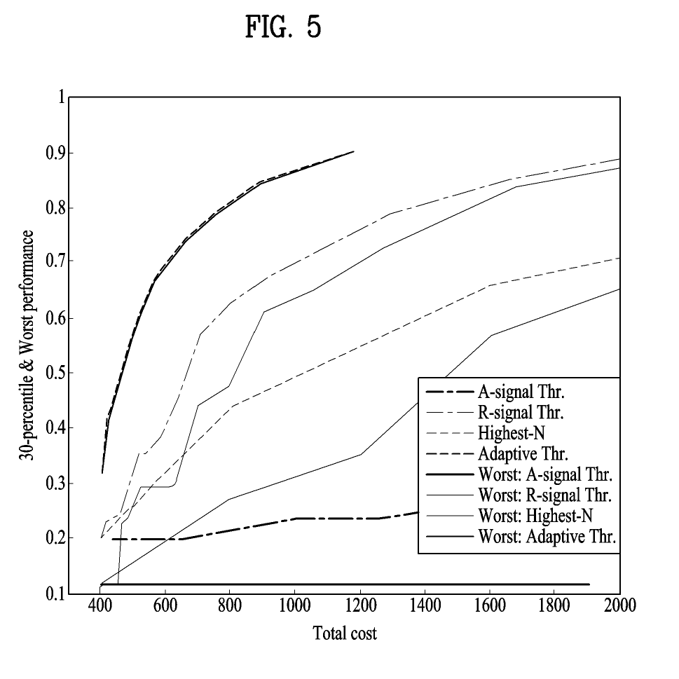

FIG. 5 is a graph illustrating the result of performance comparison between various methods for forming the UE-oriented virtual cell according to the embodiment

FIG. 5 is a graph illustrating the result of performance comparison among methods for forming the UE-oriented virtual cell. The UE-oriented virtual cell may be formed in one case in which a new UE is added to the network or in the other case in which the network environment is changed by movement of the UE position (e.g., the case in which the legacy UE-oriented cell is dislocated, and a method for forming the UE-oriented virtual cell is as follows.

1. UE measures the intensity of a signal transmitted from a base station (BS).

2. BS clustering (UE-oriented virtual cell formation)

3. Interface is formed between the UE and the UE-oriented virtual cell

4. UE-oriented virtual cell data path is formed.

In more detail, the UE receives a reference signal periodically broadcast from the BS, measures of the intensity of the reference signal (RS), and collects load information of the BS. Thereafter, the UE selects the BS cluster for forming a virtual cell (VC) according to a predetermined reference upon receiving the above collected information. Here, the selected BS cluster is a BS that constructs the UE-oriented virtual cell.

The UE may update the selected BS cluster information (i.e., UE-oriented virtual cell) to the C-RAN. Thereafter, a control signal and a radio interface for feedback are generated between one BS and the UE in the virtual cell formed by the UE. BSs constructing the virtual cell may establish a data path to store data to be transmitted to the UE.

If the UE-oriented BS cluster (i.e., the UE-oriented virtual cell) is formed, the above-mentioned cluster edge problem can be solved. In addition, assuming that the cluster is dynamically changed or generated, data/channel information should be shared or the control signal processing needs to be changed. However, if the UE-oriented virtual cell is formed, the BS cluster for transmitting data to a specific UE is fixed, so that the data/channel information sharing or the control signal processing can be easily performed among the BSs contained in the corresponding cluster.

The following four methods for forming the UE-oriented virtual cell may be used, and a detailed description thereof will hereinafter be described in detail.

The first method is the highest-N BS clustering method. In the first method, N base stations (BSs) are contained in the cluster in descending numerical order of the signal intensity. The second method is the Absolute signal threshold based clustering method. In the second method, the BS having the signal intensity of a predetermined threshold or higher is contained in the cluster. The third method is the Relative signal threshold based clustering method. In the third method, the BS having the signal intensity of a specific threshold value decided with respect to the other BS having the best signal intensity is contained in the cluster, so that the UE-oriented virtual cell is formed. The fourth method is the adaptive threshold clustering method. In the fourth method, there is a difference in network environments of respective UEs, and a threshold value is adaptively adjusted in consideration of the network environments, resulting in formation of the UE-oriented virtual cell.

The fourth method, i.e., the adaptive threshold clustering method in which the threshold value is adaptively adjusted to form the UE-oriented virtual cell will hereinafter be described in detail.

Assuming that the UE (k) and the BS (m) are contained in the C-RAN system, if the signal intensity depending on a path loss between the UE (k) and the BS (m) is higher than a specific threshold value (wmk (1+ym)/xk), the above BS (m) is set to a BS contained in the UE(k)-oriented virtual cell.

Therefore, the above-mentioned threshold value is decided according to three variables (wmk, xk, ym). The three variables (wmk, xk, ym) may indicate a network situation, performance experienced by the UE, and a value related to BS load. In conclusion, the variables (xk, ym) are adaptively decided. If UE performance is not guaranteed, a threshold value is reduced by increasing the variable (xk). If a specific BS has a large amount of load, the variable (ym) is increased to result in an increased threshold value.

Therefore, the above-mentioned fourth method is designed to use the BS(m)'s signal intensity (smk) capable of being measured by the UE (k) and the BS(m)'s load information (ym). In the fourth method, the above-mentioned variables are compared with an adaptively changing threshold value, so that a plurality of BSs appropriate for the UE (k) is contained in the virtual cell.

The result of comparison in performance and costs among the four methods in which the UE-oriented virtual cell is formed is shown in FIG. 5.

Referring to the graph of FIG. 5, the fourth method among the above-mentioned UE-oriented virtual cell formation methods has a higher cost-to-performance ratio than the remaining methods, as compared to UEs having performance of the lower-rank 30% or the worst-performance UE, so that it can be recognized that the fourth method has higher performance as compared to the remaining methods other than the fourth method.

Through the above-mentioned operations, the correlation between the performance and the cost can be easily adjusted, and a method for forming the UE-oriented virtual cell adaptively used for the network is needed. In order to properly manage the UE-oriented virtual cell without interference, a method for efficiently allocating resources to the overlapped BS clusters is needed.

That is, after formation of one or more UE-oriented virtual cells adaptively used for the network, resources are allocated to the formed multiple virtual cell, interference of a virtual cell to be used for data transmission is minimized so that the optimum transmission situation can be provided.

In accordance with the above operation for allocating resources to the UE-oriented virtual cell, actual resources are allocated among several virtual cells configured to use common radio resources, this resource allocation may be performed per timeslot, and the resource allocation and data transmission can be achieved according to the following processes (1 to 4).

1. Measurement of Channel State

2. User-oriented cell selection (UE scheduling)

3. Precoder and Power Allocation

4. Data Transmission

In more detail, a channel state related to each BS is measured per UE, the measured channel state is fed back to the C-RAN through the interface between the UE and the virtual cell, and the C-RAN may select a virtual cell to be used for data transmission on the basis of the feedback channel state information.

In addition, an optimum precoder for each virtual cell selected for data transmission and the power for each virtual cell selected for data transmission are decided, and each BS may perform data transmission on the basis of the above result.

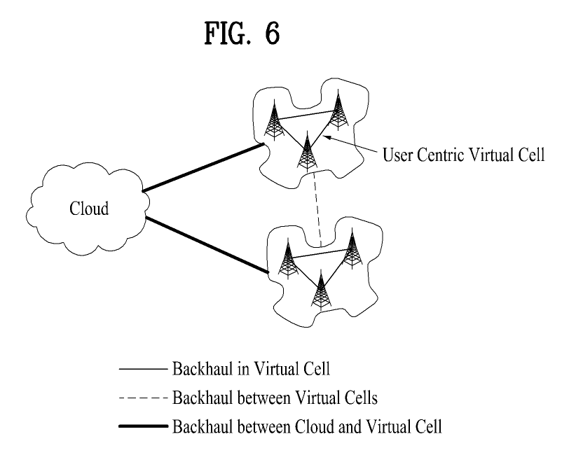

FIG. 6 illustrating the relationship between one or more UE-oriented virtual cells in the C-RAN environment according to the embodiment.

Referring to FIG. 6, the C-RAN environment according to the embodiment may include a UE-oriented cell comprised of both a cloud acting as the central processing of the C-RAN and at least one BS.

As described above, the C-RAN is a centralized structure, and controls a plurality of BSs to easily cooperate with each other, so that the C-RAN has various advantages in terms of virtualization, energy saving, device upgrade, etc.

However, the C-RAN has a disadvantage in that connection among a UE-oriented cell, a BS and a cloud should be achieved through an ideal backhaul such as high capacity and low latency.

Meanwhile, differently from the above C-RAN, the Self-Organizing Networks (SON) may be used in which each BS may self-recognize its own state without using the central coordinator so as to perform configuration or optimization.

The SON is different from the centralized structure such as the C-RAN, individual BSs perform transmission/reception of necessary information, and a necessary configuration or optimization need to be performed through the distribution algorithm.

Although the above-mentioned UE-oriented virtual cell does not require the central coordinator, if the main purpose of interference management is for beamforming, the centralized algorithm requesting the central coordinator is achieved. There is a need to develop a beamforming method for effectively removing the UE-oriented virtual cell interference and a method for deciding the precoder and power allocation needed for the beamforming even when the centrail coordinator is not present.

However, the UE must measure the above UE-oriented virtual cell and other UE-oriented virtual cell channels located in the vicinity of the UE-oriented virtual cell, and must report the measurement result to the BS. In this case, the following two problems may occur.

The first problem may indicate that the number of channels to be measured by one UE is increased, and the second problem may indicate that the number of reference signals (RSs) to be sent to the UE for channel measurement is also increased.

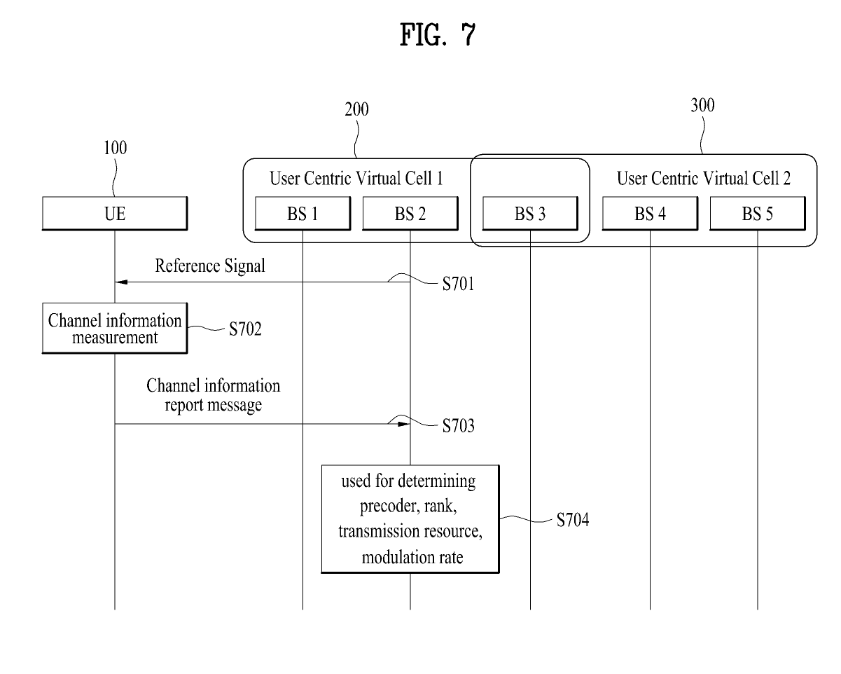

Therefore, a method for transmitting a reference signal (RS) to reduce the number of RSs to be used and a method for reducing channel estimation complexity of the UE are proposed by the present invention, and a detailed description thereof will be described later with reference to FIG. 7.

Referring back to FIG. 6, a backhaul of the UE-oriented cell in the C-RAN environment may include an intra-virtual cell backhaul between BSs contained in the UE-oriented cell, an inter-virtual cell backhaul between UE-oriented cells, and a Cloud-virtual cell backhaul between the UE-oriented cell and the cloud. The following three scenarios may be assumed in association with the above-mentioned backhauls because the UE-oriented cell has different performances according to backhaul states.

A first scenario may assume that the intra-virtual cell backhaul, the inter-virtual cell backhaul, and the cloud-virtual cell backhaul are ideal.

A second scenario may assume that only the intra-virtual cell backhaul is ideal, and the inter-virtual cell backhaul and the cloud-virtual cell backhaul are not ideal.

A third scenario may assume that the intra-virtual cell backhaul, the inter-virtual cell backhaul, and the cloud-virtual cell backhaul are not ideal.

In this case, the ideal backhaul may indicate that latency of the corresponding backhaul is set to zero (0) and the capacity of the backhaul is non-limited. For example, the ideal backhaul may indicate that channel information can be freely communicated without special limitation.

The present invention assumes the second scenario from among the above three scenarios, and proposes a method for transmitting a channel information report message under this assumption (i.e., a method for transmitting reference signals (RSs) to reduce the number of used RSs) and a method for reducing complexity of UE channel estimation.

FIG. 7 is a flowchart illustrating a method for transmitting a channel information report message in a C-RAN environment according to the embodiment.

Referring to FIG. 7, the C-RAN according to the present invention may include a first UE-oriented virtual cell 200 formed on the basis of BSs (1 to 3) and a second UE-oriented virtual cell 300 formed on the basis of BSs (3 to 5).

In accordance with the method for transmitting the channel information report message, the UE 100 may receive a reference signal (RS) from a specific BS contained in the UE-oriented virtual cell formed by the UE in step S701.

For convenience of description and better understanding of the present invention, it is assumed that the UE-oriented virtual cell formed by the UE is a first UE-oriented virtual cell and a specific BS is a second BS contained in the first UE-oriented cell.

In this case, the UE-oriented virtual cell may be formed by the UE 100 on the basis of not only the network state of the C-RAN but also the intensity and load information of the RS received from at least one BS contained in the C-RAN environment.

In addition, the RS received from BS 2 serving as the specific BS may include a reference signal (RS) configuration indicator according to the present invention, and the RS configuration indicator may include at least one RS resource used for channel information measurement. That is, the RS configuration indicator may be comprised of an aggregate of RS resources used for channel measurement.

In addition, the UE may receive a plurality of RS indicators, and RS resources transmitted through each RS indicator may be comprised of RS resources physically used by the same BS.

On the other hand, when constructing one transmit (Tx) cluster by grouping at least one BS preferred by the UE (i.e., when constructing one UE-oriented virtual cell), UE 1 may enable BSs 1 to 3 to be composed of the first UE-oriented virtual cell, and UE 2 may enable BSs 3 to 5 to be composed of the second UE-oriented virtual cell. In this case, BS 3 may be commonly used by UE 1 and UE 2.

Under this situation, BSs (1, 2, 3, 4, 5) according to the embodiment may be assigned reference signal resources (a, b, c, d, e), respectively. In addition, the first UE-oriented virtual cell formed by UE 1 includes the BSs (1, 2, 3), so that the RS configuration indicator for measuring a channel of the first UE-oriented virtual cell may be comprised of the RS resources (a, b, c) respectively allocated to BSs (1, 2, 3). The second UE-oriented virtual cell formed by the UE 2 includes the BSs (3, 4, 5), so that the RS configuration indicator may be comprised of the RS resources (c, d, e) respectively allocated to the BSs (3, 4, 5).

In addition, when the BSs (1, 2, 3, 4, 5) capable of constructing the UE-oriented virtual cell are present according to another embodiment, the RS resources (a, b, c, d, e) allocated for the respective BSs may be contained in a single common RS configuration indicator.

That is, the UE can obtain RS resources needed for channel measurement for either one of the BS contained in the first UE-oriented virtual cell and the BS of the second UE-oriented virtual cell, upon receiving not only the RS resource information contained in the common RS configuration indicator but also the UE-oriented virtual cell configuration information.

In addition, the RS configuration indicator may further include information regarding the number of transmit (Tx) layers.

Referring back to FIG. 7, the UE 100 having received the RS including the RS configuration indicator from BS 2 acting as a specific BS contained in the first UE-oriented virtual cell may measure channel information of each BS (1, 2, or 3) corresponding to the first UE-oriented virtual cell 200 on the basis of the RS configuration indicator including at least one RS resource used to measure the channel information in step S702.

When measuring the channel information, the UE is unable to recognize which precoder is used, and can use a CQI (Channel Quality Indicator) appropriate for the corresponding precoder using an arbitrary precoder. In case of MU-MIMO, it is assumed that an orthogonal precoder can be selected so that a CQI corresponding to the selected precoder may be used.

In addition, the measured channel information may include spatial channel information and channel quality information, and the UE may independently measure the spatial channel information and the channel quality information when measuring the channel information.

In this case, the spatial channel information may indicate specific information that is transmitted to BS 2 acting as the specific BS so that the specific information may be used to decide a transmit (Tx) precoder and a Tx rank of interference reduction signals to be transmitted to the UE 100. The channel quality information may be used to decide Tx resources of the interference reduction signal and the modulation rate of the interference reduction signal.

In addition, the RS configuration indicator may further include a reference signal (RS) resource allocated to at least one BS contained in the first UE-oriented virtual cell and an RS resource allocated to at least one BS contained in the second UE-oriented virtual cell neighboring with the first UE-oriented virtual cell.

In this case, according to the embodiment of the present invention, the UE may measure not only channel information of at least one BS contained in the first UE-oriented virtual cell, but also channel information of at least one BS contained in the second UE-oriented virtual cell, upon receiving the RS indicator further including RS resources allocated to at least one BS contained in the second UE-oriented virtual cell.

In addition, assuming that at least one overlap BS repeatedly contained in the first UE-oriented virtual cell and the second UE-oriented virtual cell is present as shown in BS 3 of FIG. 7, the UE may also determine channel information of BS 3 acting as the above overlap BS from among the channel information obtained on the basis of the RS configuration indicator received from BS 2 contained in the first UE-oriented virtual cell, to be channel information of BS 3 contained in the second UE-oriented virtual cell, upon receiving the RS configuration indicator received from BS 2 contained in the first UE-oriented virtual cell.

For example, assuming that channel information segments of BSs (1, 2, 3, 4, 5) are respectively denoted by H1, H2, H3, H4, and H5, channels of the first UE-oriented virtual cell decided by the UE 100 may be H1, H2, and H3, and channels of the second UE-oriented virtual cell may be denoted by H3, H4, H5.

In this case, the UE 100 may estimate the channels (H1, H2, H3) of the BSs (1, 2, 3) on the basis of the RS configuration indicator received from BS 2 contained in the first UE-oriented virtual cell. In association with BS 3 that is repeatedly present in the first UE-oriented virtual cell and the second UE-oriented virtual cell, the UE has already recognized that the channel estimation result of BS 3 contained in the first UE-oriented virtual cell is denoted by H3, so that the UE may determine the above result to be the channel estimation result of BS 3 contained in the second UE-oriented virtual cell, resulting in reduction of UE channel estimation complexity.

Referring to FIG. 7, the UE 100 having measured channel information in step S702 may transmit the channel information report message including the measured channel information to BS 2 acting as the specific BS in step S703.

In this case, the measured channel information according to the embodiment may include the spatial channel information and the channel quality information. The spatial channel information and the channel quality information may be measured independently from each other. In addition, the spatial channel information and the channel quality information from among the measured channel information may be separated from each other and then independently transmitted. That is, the measurement and Tx timing can be dualized.

Meanwhile, the BS may obtain spatial information for DL transmission through the UE-reported channel information or the UL reference signal, and may determine the Tx precoder on the basis of the obtained spatial information.

If Adaptive Modulation Coding (AMC) is performed during transmission of a data signal, Modulation and Coding Selection (MCS) appropriate for channel quality must be selected. Signal to Interference plus Noise Ratio (SINR) experienced by the UE for use in the UE-oriented virtual cell is changed according to the Tx precoders. If the UE directly measures signals employing the Tx precoder, the UE can obtain correct SINR information.

Therefore, the BS may transmit the RS for channel information measurement to the UE, and the UE may measure channel information on the basis of the RS and report the measured channel information.

In accordance with the present invention, BS 2 acting as the first UE-oriented virtual cell having received the channel information report message from the UE 100 as a response to the reference signal (RS) in step S703 may generate signals for reducing interference of the UE-oriented virtual cell generated in BS 2 corresponding to the specific BS, upon receiving the spatial channel information contained in the received channel information report message and the channel quality information.

In more detail, BS 2 may use the above spatial channel information to determine the Tx precoder and the Tx rank of signals for reducing interference of the UE-oriented virtual cell, and may decide the above channel quality information to decide Tx resources and the modulation rate of the signals used for reducing interference of the UE-oriented virtual cell in step S704.

As described above, the RS configuration indicator is designed to include the RS resource used for channel information measurement, and is then transmitted to the UE. If the BS receives the channel information report message including the spatial channel information and the channel quality information from the UE on the basis of the RS configuration indicator, and uses the received channel information report message to generate signals, the number of used RSs can be reduced and the UE channel estimation complexity can also be reduced.

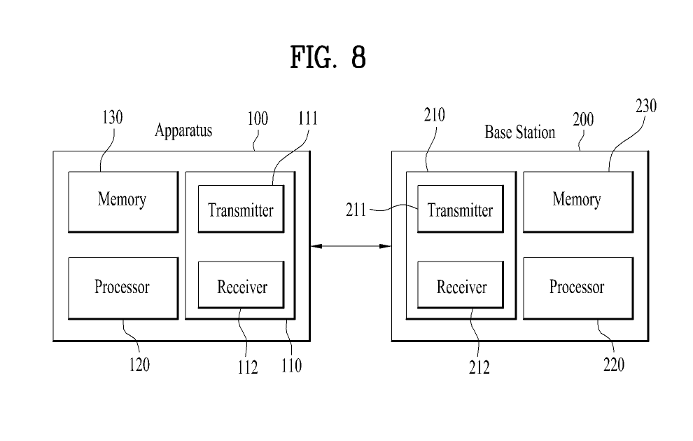

FIG. 8 is a block diagram illustrating an apparatus for transmitting a channel information report message in the C-RAN environment according to the embodiment.

The device for transmitting the channel information report message under the C-RAN environment is shown in FIG. 8. Although the device for transmitting the channel information report message includes at least one of constituent elements for convenience of description and better understanding of the present invention, the scope or spirit of the present invention is not limited thereto.

Referring to FIG. 8, the device 100 for transmitting the channel information report message includes a radio frequency (RF) unit 110, a processor 120, and a memory 130. The RF unit 110 includes a transmitter 111 and a receiver 112.

In addition, overall communication processing (such as signal processing and hierarchical processing) of the device 100 configured to transmit the channel information report message may be controlled by the processor 120 and the memory 130. The connection relationship among the RF unit 110, the processor 120, and the memory 130 may occur.

The RF unit 110 contained in the device 100 may include a transmitter 111 and a receiver 112. The transmitter 111 and the receiver 112 may be independently implemented, and may be designed to transmit/receive signals to/from the devices or to/from the BS 200.

The processor 120 is functionally connected to the transmitter 111 and the receiver 112 contained in the RF unit, and may be controlled to transmit/receive signals to/from the BS as well as to perform signal communication between the devices. In addition, the processor 120 may perform a variety of processes to be transmitted, transmit the processed result to the transmitter 111, and process signals received by the receiver 112.

If necessary, the processor 120 may store information contained in the exchanged message in the memory 130. The device 100 for transmitting the channel information report message using the above-mentioned structure may perform a variety of methods described above.

The RF unit 210 including the transmitter 211 and the receiver 212 of the BS 200 may be designed to transmit/receive signals to/from the device 100 configured to transmit the channel information report message. In addition, the processor 220 of the SB 200 is functionally connected to the transmitter 211 and the receiver 212, and the transmitter 211 and the receiver 212 may be designed to transmit/receive signals to/from other devices including the device 100 configured to transmit the channel information report message.

In addition, the processor 220 may perform a variety of processes of signals to be transmitted, may transmit the processed signals to the transmitter 211, and may perform processing of signals received by the receiver 212.

If necessary, the processor 220 may store information contained in the exchanged message in the memory 230.

The processors (120, 220) of the device 100 and the BS 200 may indicate the operations of the device 100 and the BS 200. For example, the processors (120, 220) may control, coordinate, and manage the operations of the device 100 and the BS 200. The processors (120, 220) may be respectively coupled to the memories (130, 230) capable of storing the program codes and data therein. The memories (130, 230) may be respectively coupled to the processors (120, 220), so that the memories (130, 230) may store an operating system, applications, and general files therein.

Each of the processors 120 and 220 may be referred to as a controller, a microcontroller, a microprocessor, and a microcomputer. Meanwhile, the processors 120 and 220 may be implemented by hardware, firmware, software, or a combination thereof.

If the present invention is implemented using firmware or software, firmware or software may be configured to include modules, procedures, functions, etc. performing the functions or operations of the present invention. Software codes may be stored in the memories 130 and 230, and may be driven by the processors 120 and 220. The memories 130 and 230 may be located at the interior or exterior of the device 100 and the BS 200, and the memories 130 and 230 may communicate with the processors 120 and 220 via various known means.

In a hardware configuration, Application Specific Integrated Circuits (ASICs), Digital Signal Processors (DSPs), Digital Signal Processing Devices (DSPDs), Programmable Logic Devices (PLDs), or Field Programmable Gate Arrays (FPGAs) may be included in the processors 120 and 220.

The embodiments of the present invention may be written as computer programs and can be implemented in general-use digital computers that execute the programs using a computer readable recording medium. In addition, a structure of data used in the above-described method may be recorded in a computer readable recording medium through various methods. Program storage devices used for description of a storage device containing an executable computer code for execution of the various methods according to the present invention is not understood as temporary objects such as carrier waves or signals. Examples of the computer readable recording medium include magnetic storage media (e.g., ROMs, floppy disks, hard disks, etc.) and optical recording media (e.g., CD-ROMs, or DVDs).

It will be apparent to those skilled in the art that various modifications and variations can be made in the present invention without departing from the spirit or scope of the invention. Therefore, the above embodiments should be construed in all aspects as illustrative and not restrictive. The scope of the invention should be determined by the appended claims and their legal equivalents, not by the above description, and all changes coming within the meaning and equivalency range of the appended claims are intended to be embraced therein.

The method for transmitting the channel information report message in the C-RAN environment can be applied to various systems and devices configured to transmit the channel information report message.

As is apparent from the above description, the embodiments can provide a method for transmitting a channel information report message in a cloud radio access network (C-RAN) environment.

The embodiments can provide a method for transmitting a reference signal (RS) to reduce the number of RSs needed for channel measurement in the C-RAN environment.

The embodiments can provide a method for transmitting a channel information report message to reduce complexity of UE channel estimation in the C-RAN environment.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for transmitting a channel information report message by a user equipment (UE) under a cloud radio access network (C-RAN) environment, comprising:
receiving a reference signal (RS) including a reference signal (RS) configuration indicator from a specific base station (BS) contained in a UE-oriented virtual cell formed by the UE;
measuring channel information regarding each of one or more base stations (BSs) contained in the UE-oriented virtual cell on the basis of the RS configuration indicator; and
transmitting a channel information report message including the measured channel information to the specific base station (BS),
wherein the RS configuration indicator includes one or more RS resources used for channel information measurement, and the one or more RS resources are allocated to one or more base stations (BSs) contained in the UE-oriented virtual cell.

2. The method according to claim 1, wherein the UE-oriented virtual cell is formed by the user equipment (UE) on the basis of not only a network state of the C-RAN, but also intensity and load information of the reference signal (RS) received from each BS contained in the C-RAN environment.

3. The method according to claim 1, wherein:
the measured channel information includes spatial channel information and channel quality information,
wherein the spatial channel information is used to decide a transmission (Tx) precoder and a transmission (Tx) rank of signals needed for reducing interference generated from the specific base station (BS), and the channel quality information is used to decide not only a transmit (Tx) resources of the signals needed for the interference reduction but also a modulation rate.

4. The method according to claim 3, wherein the transmitting the channel information report message includes:
separating the spatial channel information and the channel quality information from each other, and transmitting the separated spatial channel information and the channel information.

5. The method according to claim 1, wherein the reference signal (RS) configuration indicator further includes:
a reference signal (RS) resource allocated to each base station (BS) contained in other UE-oriented virtual cell neighboring with the UE-oriented virtual cell.

6. The method according to claim 5, wherein the measuring the channel information includes:
measuring channel information of each BS contained in the UE-oriented virtual cell and channel information of each BS contained in the other UE-oriented virtual cell, on the basis of the reference signal configuration indicator further including a reference signal (RS) resource allocated to each BS contained in the other UE-oriented virtual cell.

7. The method according to claim 1, wherein:
at least one overlap base station (BS) simultaneously contained in the UE-oriented virtual cell and other UE-oriented virtual cell neighboring with the UE-oriented virtual cell is present, and
among channel information measured on the basis of the RS configuration indicator received from the specific BS contained in the UE-oriented virtual cell, channel information of the overlap BS is determined to be channel information regarding the overlap BS contained in the other UE-oriented virtual cell.

8. The method according to claim 1, wherein the RS configuration indicator further includes information regarding the number of transmission (Tx) layers.

9. An apparatus for transmitting a channel information report message in a cloud radio access network (C-RAN) environment, comprising:
a radio frequency (RF) unit configured to include a transmitter and a receiver; and
a processor connected to the transmitter and the receiver to support communication of the apparatus,
wherein the processor receives a reference signal (RS) including a reference signal (RS) configuration indicator from a specific base station (BS) contained in a UE-oriented virtual cell formed by a user equipment (UE), measures channel information regarding each of one or more base stations (BSs) contained in the UE-oriented virtual cell on the basis of the RS configuration indicator, and transmits a channel information report message including the measured channel information to the specific base station (BS),
wherein the RS configuration indicator includes one or more RS resources used for channel information measurement, and the one or more RS resources are allocated to one or more base stations (BSs) contained in the UE-oriented virtual cell.

10. The apparatus according to claim 9, wherein the processor forms the UE-oriented virtual cell on the basis of not only a network state of the C-RAN, but also intensity and load information of the reference signal (RS) received from each BS contained in the C-RAN environment.

11. The apparatus according to claim 11, wherein:
the measured channel information includes spatial channel information and channel quality information,
wherein the spatial channel information is used to decide a transmission (Tx) precoder and a transmission (Tx) rank of signals needed for reducing interference generated from the specific base station (BS), and the channel quality information is used to decide not only a transmit (Tx) resources of the signals needed for the interference reduction but also a modulation rate.

12. The apparatus according to claim 11, wherein the processor separates the spatial channel information and the channel quality information from each other, and transmits the separated spatial channel information and the channel information.

13. The apparatus according to claim 9, wherein the reference signal (RS) configuration indicator further includes:
a reference signal (RS) resource allocated to each base station (BS) contained in other UE-oriented virtual cell neighboring with the UE-oriented virtual cell.

14. The apparatus according to claim 13, wherein the processor measures channel information of each BS contained in the UE-oriented virtual cell and channel information of each BS contained in the other UE-oriented virtual cell, on the basis of the reference signal configuration indicator further including a reference signal (RS) resource allocated to each BS contained in the other UE-oriented virtual cell.

15. The apparatus according to claim 9, wherein:
at least one overlap base station (BS) simultaneously contained in the UE-oriented virtual cell and other UE-oriented virtual cell neighboring with the UE-oriented virtual cell is present, and
the processor determines channel information of the overlap BS from among channel information measured on the basis of the RS configuration indicator received from the specific BS contained in the UE-oriented virtual cell, to be channel information regarding the overlap BS contained in the other UE-oriented virtual cell.

16. The apparatus according to claim 9, wherein the RS configuration indicator further includes information regarding the number of transmission (Tx) layers.

17. A method for receiving a channel information report message by a base station (BS) contained in a UE-oriented virtual cell formed by a user equipment (UE) under a cloud radio access network (C-RAN) environment, comprising:
transmitting a reference signal (RS) including a reference signal (RS) configuration indicator to the UE; and
receiving a channel information report message including channel information of each of one or more base stations (BSs) contained in the UE-oriented virtual cell measured on the basis of the RS configuration indicator from the UE,
wherein the RS configuration indicator includes one or more RS resources used for channel information measurement, and the one or more RS resources are allocated to one or more base stations (BSs) contained in the UE-oriented virtual cell.
